(19) United States
(12) Patent Application Publication
(10) Pub. No.: US 2013/0298863 A1
(43) Pub. Date: Nov. 14, 2013

(54) IGNITION SYSTEM AND OPERATING METHOD FOR SAME

(71) Applicants: Karl-Heinz Nuebel, Simmozheim (DE); Manfred Vogel, Ditzingen (DE); Frank Barth, Tamm (DE); Martin Weinrotter, Vitoria-Gasteiz (ES)

(72) Inventors: Karl-Heinz Nuebel, Simmozheim (DE); Manfred Vogel, Ditzingen (DE); Frank Barth, Tamm (DE); Martin Weinrotter, Vitoria-Gasteiz (ES)

(21) Appl. No.: 13/885,576

(22) PCT Filed: Sep. 13, 2011
(86) PCT No.: PCT/EP2011/065818

§ 371 Date: Aug. 5, 2013

(30) Foreign Application Priority Data
Nov. 15, 2010 (DE) 10 2010 043 893.6

(51) Int. Cl. F02P 23/04

(52) U.S. Cl. CPC F02P 23/04
USPC 123/143 B

(57) ABSTRACT

An ignition system is described, in particular for an internal combustion engine of a motor vehicle, having a laser spark plug, a pump module for supplying the laser spark plug with pump radiation, and an optical fiber device for transmitting the pump radiation from the pump module to the laser spark plug. At least two separate signal transmission devices which each extend at least partially along the optical fiber device, and an evaluation unit, which is designed to act on each of the signal transmission devices with a test signal, to evaluate a response signal of the signal transmission devices which results from the particular test signal, and from the response signal to deduce an operating state of the corresponding signal transmission device, are provided.

### FIELD

The present invention relates to an ignition system, in particular for an internal combustion engine of a motor vehicle, having a laser spark plug, a pump module for supplying the laser spark plug with pump radiation, and an optical fiber device for transmitting the pump radiation from the pump module to the laser spark plug. The present invention also relates to an operating method for this type of ignition system.

### BACKGROUND INFORMATION

Laser-based ignition systems of the above-mentioned type generally require transmission of high optical power with the aid of optical fibers. In particular the pump radiation used for optically pumping components of the laser spark plug may assume quite high values. For increasing the laser safety of such systems, optical fiber devices may be used which, in addition to optically conductive fibers, have at least one metallic layer via which the optical fibers are mechanically protected.

However, the proper optical connection between the pump module and the laser spark plug to be supplied with pump radiation, or also the proper installation of the laser spark plug in a target system, for example a cylinder head of an internal combustion engine, is not verifiable using the conventional devices and methods, which impairs the laser safety of the conventional systems.

### SUMMARY

An object of the present invention is to improve an ignition system and an operating method for an ignition system in such a way that efficient and reliable determination of an operating state of the optical fiber device, in particular an optical integrity of the optical fiber device, is possible.

In accordance with an example embodiment of the present invention, an ignition system is provided having at least two separate signal transmission devices which each extend at least partially along the optical fiber device are provided, and an evaluation unit is provided which is designed to
act on each of the signal transmission devices with a test signal,
evaluate a response signal of the signal transmission devices which results from the particular test signal, and
deduce from the response signal an operating state of the corresponding signal transmission device.

Providing at least two separate signal transmission devices in accordance with the present invention is particularly advantageous, since a redundant and therefore particularly reliable option for diagnosis is thus provided. Use is made of the effect that damage to the optical fiber device, which could possibly result in laser radiation escaping from the optical fiber device, generally also causes at least one impairment of at least one of the signal transmission devices provided according to the present invention, so that this type of impairment of the affected components is determinable within the scope of evaluating the response signals obtained according to the present invention. On this basis, damage to the optical fiber device or at least the risk of imminent damage to the optical fiber device may advantageously be deduced, thus significantly increasing the safety of the laser-based ignition system.

The at least two separate signal transmission devices according to the present invention are preferably independent of one another, and in particular may thus be monitored independently of one another.

In one advantageous specific embodiment, it is provided that the first signal transmission device has at least one first electrical transmission path between the evaluation unit and an area of a housing of the laser spark plug which is connected to an electrical reference potential of the target system when the laser spark plug is properly installed in a target system, for example a cylinder head of an internal combustion engine. The evaluation unit is particularly preferably situated in the area of the pump module, i.e., remote from the laser spark plug which is installed in the target system (internal combustion engine). Alternatively, the evaluation unit according to the present invention may be integrated into an existing pump module or a comparable control device of the ignition system.

Providing an electrical transmission path between the evaluation unit and a housing area of the laser spark plug, which may be set at a defined reference potential, or which may already be connected to a defined reference potential such as the ground potential of the internal combustion engine or the motor vehicle containing same, advantageously allows the formation of a simple test current circuit between the evaluation unit, over the first electrical transmission path and the housing area of the laser spark plug, to the reference potential of the target system. In specific embodiments, a reference potential of the evaluation unit will be identical to the reference potential of the target system, for example the ground potential of the motor vehicle, so that test pulses designed as voltage pulses may be emitted from the evaluation unit to the first signal transmission device, and the integrity of the first signal transmission device may be deduced from the current flowing through the transmission path.

In another particularly advantageous specific embodiment of the ignition system according to the present invention, it is provided that the first electrical transmission path has an electrically conductive tube which surrounds the optical fiber device, for example coaxially.

In this configuration, mechanical protection of the optical fiber device situated in the electrically conductive tube is advantageously provided at the same time, and the first electrical transmission path is implemented between the evaluation unit and the laser spark plug.

The electrically conductive tube is particularly preferably designed as a metal tube, resulting in particularly high mechanical stability, and thus associated protection of the optical fiber device from external influences. In this regard, even more important is the aspect of also protecting the surroundings from escaping laser light when the optical fiber device is composed of a fiber bundle, for example, in which a few fibers are broken, and high-energy light then escapes from them. If this light finds a gap in the protective tube and strikes the human eye, blindness may result. This is effectively prevented by the metal tube. The metal tube may be designed, for example, as a wound spiral tube or as a seamless corrugated tube, the second design being preferred (due to the risk of light escaping at the folds of the wound tube).

In another specific embodiment, it is provided that the second signal transmission device has at least one second electrical transmission path between the evaluation unit and a connecting area of the optical fiber device to the laser spark plug, the second electrical transmission path preferably having an insulated electrical conductor which is situated generally along the optical fiber device and/or the electrically conductive tube surrounding the optical fiber device. Accordingly, in this variant of the present invention the at least two signal transmission devices are designed as electrical signal transmission devices. Similarly as for the first signal transmission device, the second electrical transmission path of the second signal transmission device may also be connected at its first end region to the evaluation unit, while a second end region of the second electrical transmission path is electrically connectable to the laser spark plug or to an electrically conductive area of the target system, for example the cylinder head of an internal combustion engine.

During the installation of the laser spark plug in the target system, the electrically conductive connection between the second electrical transmission path and the evaluation unit may thus be established at the same time, so that as a result of the test pulses provided according to the present invention, it is advantageously determinable whether the second signal transmission device is properly connected to the cylinder head of the internal combustion engine.

Alternatively or in addition to the electrical design of the at least two signal transmission devices, an optical design of at least one signal transmission device may be provided. In this case, in addition to the optical fiber device, for example a further optical fiber may be provided between the evaluation unit and the laser spark plug, which is situated, for example, in such a way that a first end region of the second optical fiber is optically connected to the evaluation unit, the second optical fiber is situated along the optical fiber device toward the laser spark plug, and the second optical fiber continues in the direction of the evaluation unit past the installation site of the laser spark plug in order to ultimately be optically connected to the evaluation unit, an optical measuring loop thus resulting from the second optical fiber.

Alternatively or additionally, an optically designed signal transmission device may have a reflector in the area of the laser spark plug which allows back-reflection of optical test pulses, emitted by the evaluation unit in the same fiber, to the evaluation unit. In another advantageous specific embodiment, it may also be provided that test pulses are irradiated directly into the optical fiber device, which is used primarily for relaying pump radiation, and that in the end region of the optical fiber device associated with the laser spark plug, reflector means are once again provided for reflecting the test pulses, corresponding reflections at the area of the optical fiber device associated with the evaluation unit being extractable by a filter, and evaluatable by the evaluation unit.

Redundant monitoring for interruption of the signal transmission devices may generally be carried out using the principle according to the present invention. Namely, if no current flow is detectable in an electrical signal transmission device, complete interruption of the corresponding electrical transmission path, and thus also an interruption of or at least damage to the optical fiber device, may be deduced. The evaluated result concerning the first signal transmission device may advantageously be checked for plausibility by evaluating the response signals optionally obtained from the further signal transmission device.

As a whole, by providing the at least two signal transmission devices, a dual-channel system for monitoring the integrity of the optical fiber device or of a cable connection containing the optical fiber device, and also containing, at least in parts, the signal transmission devices according to the present invention, may be implemented, so that a redundant dual-channel monitoring system may be provided.

In another advantageous specific embodiment, it is provided that at least one, but preferably all, signal transmission device(s) is/are situated along the optical fiber device and extend(s) over at least 80% of the total length of the optical fiber device, resulting in a particularly comprehensive option for monitoring or checking the integrity of the optical fiber device over its length.

Alternatively or in addition to an electrical or optical signal transmission device, as the result of another specific embodiment at least one signal transmission device may have a wireless, i.e., radio-based, transmission path, at least in parts. For example, a signal transmission device designed primarily as an electrical signal transmission device may have a wired electrical transmission path, for example a cable, along optical fiber device 130 over a first length region. A radio link which is formed by two transceivers in communication with one another may be connected over a second length region, one of the transceivers being connected to the first section of the signal transmission device, namely, the wired electrical transmission path.

In another advantageous specific embodiment, multiple homogeneous signal transmission devices are provided.

In yet another advantageous specific embodiment, it is provided that the evaluation unit is designed to simultaneously or consecutively act on multiple signal transmission devices with test signals in order to deduce an optical integrity of the optical fiber device from response signals thus obtained.

In yet another specific embodiment, it is provided that in order to increase the laser safety of the ignition system, the pump module is deactivatable when an error has been ascertained in the area of at least one signal transmission device.

For example, a predefinable deviation from a regular transmission function of the signal transmission device may be defined as an error in the area of at least one signal transmission device. When an electrical signal transmission device is provided which implements a simple current loop, for example, a predefinable change in an electrical resistance, in particular the direct current resistance, may be interpreted as an error within the meaning of the present invention. The change in an alternating current resistance, or in a spectral transmission characteristic in general, is also usable as a monitoring criterion.

In an example method according to the present invention, at least two separate signal transmission devices which each extend at least partially along the optical fiber device are provided, and an evaluation unit acts on each of the signal transmission devices with a test signal, evaluates a response signal of the signal transmission devices which results from the particular test signal, and from the response signal deduces an operating state of the corresponding signal transmission device.

Further features, applications, and advantages of the present invention result from the following description of exemplary embodiments of the present invention, which are illustrated in the figures. All described or illustrated features, alone or in any given combination, constitute the subject matter of the present invention, independently of their wording or illustration in the description below or figures, respectively.

### BRIEF DESCRIPTION OF THE DRAWINGS

FIG. 1a schematically shows a first specific embodiment of an ignition system according to the present invention.

FIG. 1b schematically shows another specific embodiment of the ignition system according to the present invention in an internal combustion engine.

FIG. 2 schematically shows another specific embodiment of the ignition system.

FIG. 3 schematically shows a detailed view of another specific embodiment of the present invention.

FIG. 4 schematically shows a partial cross section of a connecting area of another specific embodiment of the ignition system according to the present invention, in an enlarged illustration.

FIG. 5a shows a connecting area of another specific embodiment of the present invention in the area of a laser spark plug.

FIG. 5b shows a connecting area of the specific embodiment according to FIG. 5a in the area of an evaluation unit.

FIG. 6 shows a simplified electrical equivalent circuit diagram of components of an evaluation unit according to the present invention.

FIG. 7 schematically shows another specific embodiment of an ignition system according to the present invention.

FIG. 8 shows a simplified flow chart of one specific embodiment of the method according to the present invention.

FIG. 9 shows a detailed view of a laser device for the ignition system according to FIG. 1b.

FIG. 10 shows a detailed view of another specific embodiment.

FIGS. 11a through 11c show various specific embodiments of an electrical transmission path for use with the ignition system according to FIG. 1a.

FIGS. 12a through 12d show further specific embodiments of the present invention.

### DETAILED DESCRIPTION OF EXAMPLE EMBODIMENTS

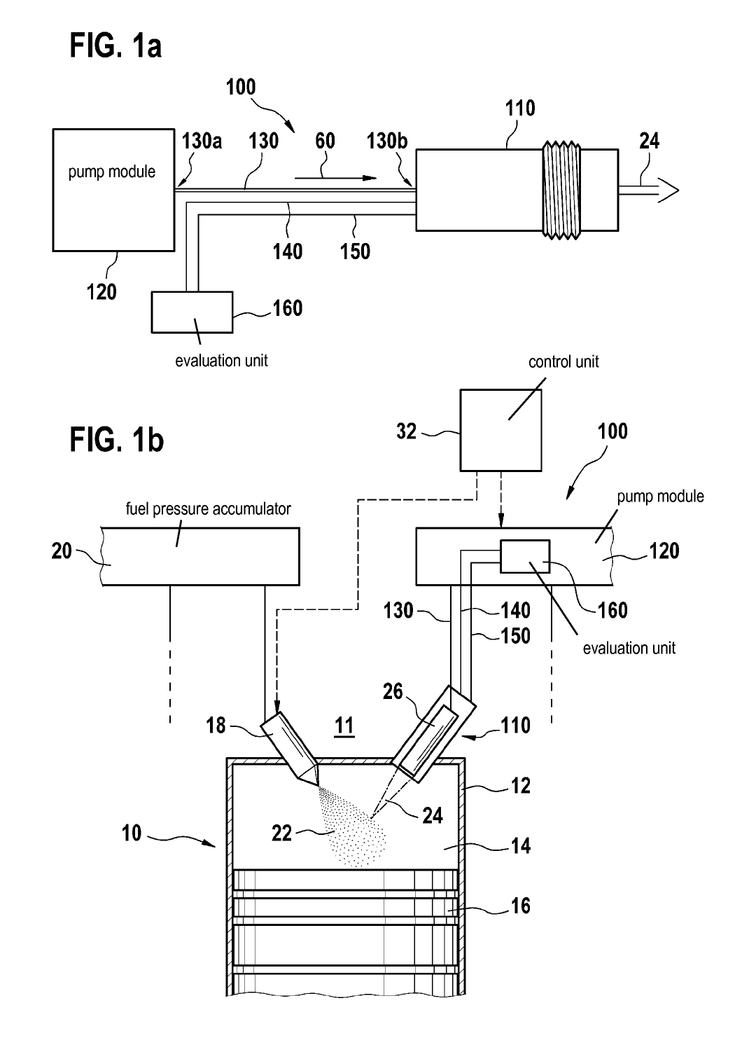

FIG. 1a schematically shows a first specific embodiment of an ignition system 100 according to the present invention, which is provided for generating laser ignition pulses 24 and used in an internal combustion engine for igniting an ignitable air-fuel mixture.

For this purpose, ignition system 100 has a laser spark plug 110 which generates and emits laser ignition pulses 24 in a manner known per se. Ignition system 100 also has a pump module 120 which has at least one pumped light source (not shown) that generates pump radiation 60 for optically pumping at least one component of laser spark plug 110. An optical fiber device 130 is provided between pump module 120 and laser spark plug 110 for transmitting pump radiation 60 from pump module 120, which is usually situated remotely from laser spark plug 110, to laser spark plug 110.

To allow checking of the integrity of optical fiber device 130, in particular during operation of ignition system 100, according to the present invention two separate signal transmission devices 140, 150 which each extend at least partially along optical fiber device 130 are provided. Signal transmission devices 140, 150 are generally used for transmitting signals, with the purpose that an interruption or impairment of the signal transmission is evaluatable by an evaluation unit 160 which likewise is associated with ignition system 100, so that the presence of an error or a mechanical interruption of signal transmission device 140, 150 may be deduced. Since according to the example embodiment of the present invention, signal transmission devices 140, 150 are situated along optical fiber device 130 at least in parts, when an error is recognized by evaluation unit 160 in the area of signal transmission devices 140, 150 it is generally also possible to deduce an error in the area of optical fiber device 130, in particular an interruption or impairment of optical fiber device 130 (this also includes the sheath of the optical fiber device).

Particularly comprehensive monitoring of optical fiber device 130 is advantageously possible when at least one of signal transmission devices 140, 150 extends over a significant portion of the overall length of optical fiber device 130. This is the case in the present specific embodiment shown in FIG. 1a, since both signal transmission devices 140, 150 extend from a first connecting area 130a of optical fiber device 130 to pump module 120, all the way to a second connecting area 130b of optical fiber device 130 to laser spark plug 110.

Evaluation unit 160 is designed to act on each of signal transmission devices 140, 150 with a test signal to evaluate a response signal of signal transmission devices 140, 150 which results from the particular test signal, and to deduce from the response signal an operating state of corresponding signal transmission devices 140, 150.

By providing at least two signal transmission devices 140, 150 which operate separately, i.e., independently of one another, and in particular transmit the particular test signals, redundant monitoring of components 140, 150, and thus also of the state of optical fiber device 130, is advantageously provided.

FIG. 1b shows ignition system 100 according to FIG. 1a in a corresponding configuration in an internal combustion engine 10.

Internal combustion engine 10 is used, for example, to drive a motor vehicle, not illustrated, or is designed as a stationary gas engine or the like. Internal combustion engine 10 includes multiple cylinders, of which only one is denoted by reference numeral 12 in FIG. 1b. A combustion chamber 14 of cylinder 12 is delimited by a piston 16. Fuel reaches combustion chamber 14 directly via an injector 18, which is connected to a fuel pressure accumulator 20, also referred to as a rail.

Fuel 22 injected into combustion chamber 14 is ignited with the aid of a laser pulse 24 which is radiated into combustion chamber 14 by laser spark plug 110 having a laser device 26. For this purpose, laser device 26 is supplied with pump radiation 60, provided by pump module 120, via optical fiber device 130 described above with reference to FIG. 1a. Pump module 120 is controlled by a control unit 32 which also controls injector 18.

Previously described signal transmission devices 140, 150 according to the present invention, which once again are situated along optical fiber device 130, are apparent from FIG. 1b. As indicated in FIG. 1b, evaluation unit 160 may be situated in pump module 120, for example. Alternatively, it may be situated in control unit 32, or be designed as a separate external unit.

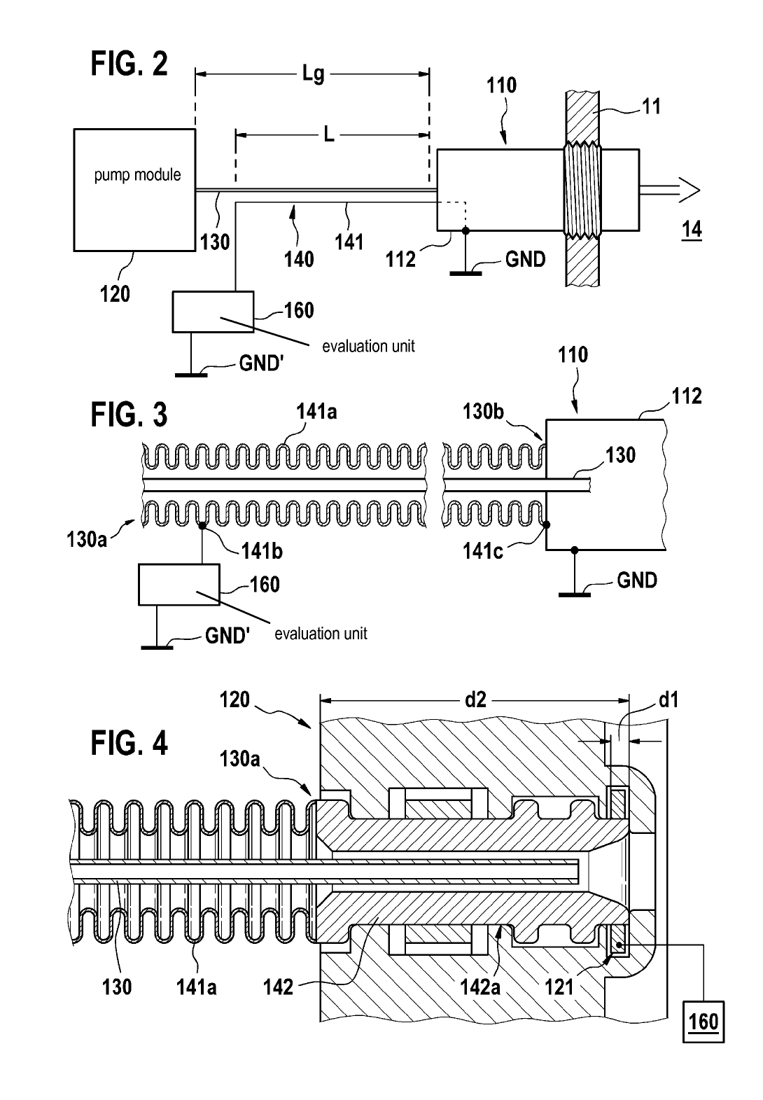

FIG. 2 shows one specific embodiment of ignition system 100 according to the present invention, in which first signal transmission device 140 is designed as an electrical signal transmission device. Second signal transmission device 150, which in principle may likewise have an electrical, optical, or some other design, is not illustrated in FIG. 2 for the sake of clarity.

As is apparent from FIG. 2, first signal transmission device 140 with its electrical transmission path 141, implemented by an electrically insulated conductive protective tube, for example, extends over a length segment L along optical fiber device 130, which has an overall length Lg between pump module 120 and laser spark plug 110. Signal transmission device 140 preferably extends over entire length Lg of optical fiber device 130, and in particular L≧0.8×Lg. Particularly comprehensive monitoring of the integrity of optical fiber device 130 is thus possible using first signal transmission device 140. The same applies for second signal transmission device 150 (FIG. 1a).

Evaluation unit 160 has a reference potential GND′ which may be designed, for example, as the ground potential of the motor vehicle or the internal combustion engine containing ignition system 100. Laser spark plug 110, which is shown in FIG. 2 in its installed position in a cylinder head 11 of internal combustion engine 10 (FIG. 1b), is likewise connected to a ground potential GND, as formed by cylinder head 11 as a result of this installed position, and thus, the electrical contact with cylinder head 11. Electrical transmission path 141 between evaluation unit 160 and laser spark plug 110, in particular an electrically conductive housing 112 of laser spark plug 110, which, as is apparent from FIG. 2, is connected to ground potential GND of cylinder head 11 in an electrically conductive manner, results in a current loop between evaluation unit 160 and laser spark plug 110, which in the form of signal transmission device 140 covers a substantial length segment L of optical fiber device 130. This means that mechanical damage to conductor devices 130, 140, which are essentially adjacently situated over length region L, or improper installation (for example, the laser spark plug is not screwed in) generally acts on both conductor devices 130, 140, so that an electrically detectable impairment of first signal transmission device 140 is evaluatable, and based on such an impairment of first signal transmission device 140, evaluation unit 160 may also deduce an impairment of the optical integrity of optical fiber device 130.

A simple electrical equivalent circuit diagram of one specific embodiment of evaluation unit 160 according to the present invention is shown in FIG. 6.

The evaluation unit has a voltage source 162, for example a direct current voltage source, which, as illustrated, is connected to reference potential GND′ of the evaluation unit. First electrical transmission path 141 of first signal transmission device 140 (FIG. 2) may be selectively connected to voltage source 162 via a switch 166 that is controllable by control unit 160a of evaluation unit 160, so that a voltage pulse which is usable as a test signal may be emitted to signal transmission device 140. A current meter 164 of evaluation unit 160 detects the current flowing through electrical transmission path 141 to laser spark plug 110, and ultimately, to motor vehicle ground GND in the area of cylinder head 11. If little or no current flow is detected, an interruption or impairment of first signal transmission device 140 or of first electrical transmission device 141 is deduced, which may be recognized by evaluation unit 160 as an error state.

A current threshold, for example, may advantageously be predefined which within the scope of the evaluation according to the present invention may be used to distinguish between response signals (current pulses) which result from the voltage pulses. If the current is below a predefinable current threshold, an error in the area of first signal transmission device 140 may accordingly be deduced, while if the current threshold is exceeded, a sufficiently good electrically conductive connection in the area of electrical transmission path 141, and thus proper operation of signal transmission device 140, may be deduced.

In this case, evaluation unit 160 also preferably deduces that optical fiber device 130 is undamaged.

FIG. 8 shows a simplified flow chart of one specific embodiment of a method according to the present invention. Signal transmission device 140 is acted on by a test signal, for example a voltage pulse (FIG. 6), in a first step 200. A similar procedure may be followed for a second signal transmission device 150 (FIG. 1a), likewise designed as an electrical signal transmission device.

A response signal of signal transmission devices 140, 150 which results from the particular test signal (voltage pulse) is evaluated in a second step 210 according to FIG. 8.

Lastly, based on the previously obtained response signals, an operating state of corresponding signal transmission device 140, 150 is deduced in a further step 220. The state of optical fiber device 130 may advantageously be deduced from this evaluation result.

While in the specific embodiment of evaluation unit 160 illustrated in FIG. 6, only a selective, alternatingly exclusive connection of transmission paths 141, 151 to voltage source 162 is possible, and therefore the two transmission paths 141, 151 may be acted on only in alternation by test signals designed as voltage pulses, in another specific embodiment of the present invention it may be provided that both transmission paths 141, 151, or in general all transmission paths, of the ignition system may simultaneously be acted on by an appropriate test signal.

The measuring principle discussed above with reference to FIG. 6 is similarly applicable to optical transmission devices, whereby instead of an electrical current, the occurrence of reflections, generated by reflector means provided in the area of laser spark plug 110, in response to test pulses radiated by evaluation unit 160 is evaluated.

FIG. 3 shows another specific embodiment of the ignition system according to the present invention in detail. In this specific embodiment, electrical transmission path 141 (FIG. 2) of first signal transmission device 140 is advantageously designed as an electrically conductive tube 141a. Electrically conductive tube 141a may particularly preferably be designed as a metal tube, and thus, in addition to implementing electrical transmission path 141, at the same time is used for mechanical protection of optical fiber device 130 guided therein.

An electrical connection is situated between electrically conductive tube 141a and evaluation unit 160 (see circuit node 141b) in a first connecting area 130a of optical fiber device 130. Another electrically conductive connection 141c is provided in connecting area 130b of optical fiber device 130 facing laser spark plug 110, between electrically conductive tube 141a and housing 112 of laser spark plug 110, which, due to laser spark plug 110 being situated in cylinder head 11, is at ground potential GND of a motor vehicle or of internal combustion engine 10.

FIG. 4 shows a detailed view of a connecting area 130a in the area of pump module 120 in another specific embodiment of the ignition system according to the present invention. As described above with reference to FIG. 3, in the present specific embodiment as well, optical fiber device 130 is guided in a metallic tube 141a. An end region 142 of metallic tube 141a which protrudes into pump module 120 is connected via a detent connection 142a to corresponding receptacles in pump module 120. This ensures that tube 141a is connectable to pump module 120, and in particular is again detachable from same, only when acted on by appropriate axial forces.

An electrical contact between electrically conductive tube 141a and an evaluation unit 160, which in the present case is integrated into pump module 120, is particularly preferably implemented by, for example, a ring- or fork-shaped contact element 121 into which end region 142 of electrically conductive tube 141a may be inserted in its connection position shown in FIG. 4. An overlap length or contact length of end region 142 with contact ring 121 is denoted by reference numeral d1. In comparison to a length d2 of connecting piece 142 or a corresponding receptacle for connecting piece 142 of pump module 120, contact length d1 is selected to be small enough that pulling out tube 141a or connecting piece 142 from pump module 120, after an axial motion of tube 141a to the left in FIG. 4 by length d1, results in a loss of the electrical contact between tube 141a or contact piece 142 and evaluation unit 160, i.e., long before connecting piece 142 has completely moved from the receptacle in pump module 120 having length d2>d1. It is thus ensured that the detection principle according to the present invention is able to detect the interruption of the electrical contact between components 142, 121 in a timely manner in order to deactivate pump module 120 or a pumped light source contained therein before tube 141a or end piece 142 has been completely pulled from pump module 120 or the receptacle in question due to the action of axial tensile force, which could allow pump radiation 60 to escape into the surroundings of pump module 120.

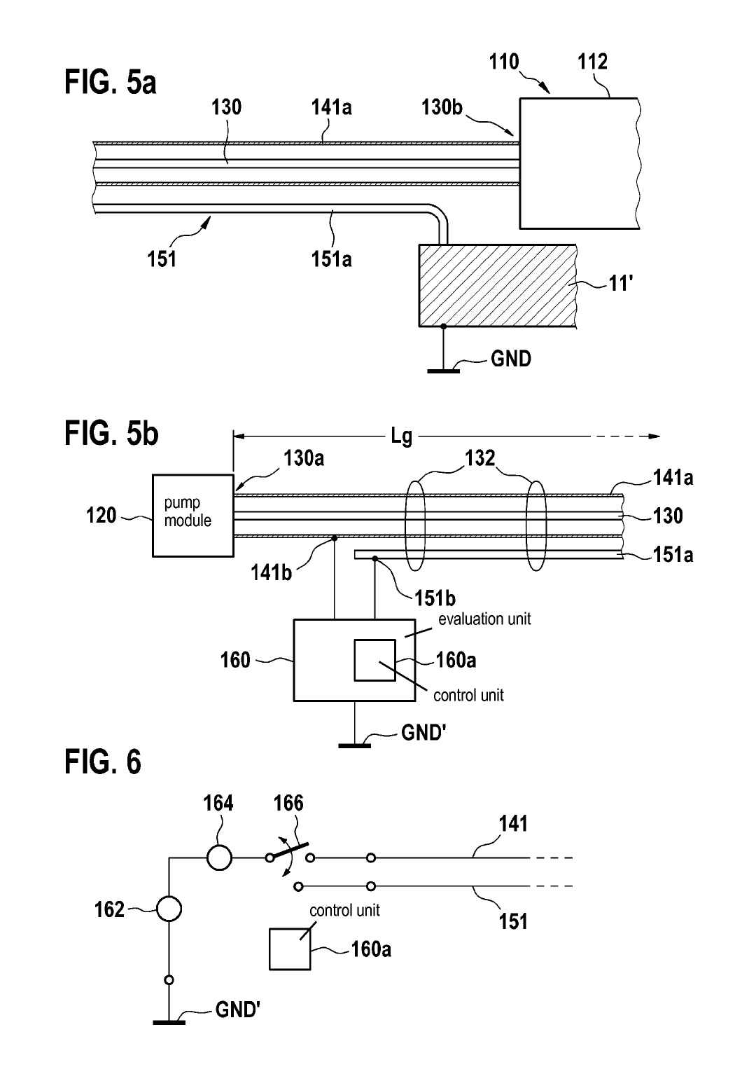

FIG. 5a shows a connecting area 130b of another specific embodiment of the present invention, in which an electrically conductive tube 141a which surrounds optical fiber device 130 is once again provided. As described above with reference to FIG. 3, for example, electrically conductive tube 141a is connected to housing 112 of laser spark plug 110 in an electrically conductive manner. To implement second signal transmission device 150 according to the present invention, in the present case a second electrical transmission path 151 is provided which is formed, for example, by an insulated electrical conductor 151a. Insulated electrical conductor 151a is electrically connected to an area 11′ of cylinder head 11 (FIG. 1b) of internal combustion engine 10 at a reference potential GND. Electrical conductor 151a is electrically insulated from electrically conductive tube 141a, so that no interactions occur between test pulses guided in the two electrical conductors.

FIG. 5b shows a connecting area 130a of the configuration from FIG. 5a in the area of pump module 120. Optical fiber device 130 is optically connected to pump module 120 for coupling pump radiation 60 into optical fiber device 130. For implementing comprehensive mechanical protection for optical fiber device 130, electrically conductive tube 141a is likewise guided to pump module 120, so that the tube encloses optical fiber device 130 over its entire length Lg (FIG. 2).

Electrically conductive tube 141a is electrically connected to evaluation unit 160 via node 141b. An electrical connection of second electrical transmission path, which is formed by insulated electrical conductor 151a, is achieved via further node 151b. In this way, evaluation unit 160 may act on both transmission paths 141a, 151a with test pulses in accordance with the present invention in order to deduce from the resulting current pulses a proper connection to a reference potential GND or an interruption.

As described above, electrically insulated conductor 151a is in particular also electrically insulated from electrically conductive tube 141a so that a dual-channel measurement is possible.

As the result of another specific embodiment, components 130, 141a, 151a may be mechanically connected to one another in a particularly advantageous manner by the connectors which surround them (see reference numeral 132 in FIG. 5b). These connectors may also be implemented, for example, as a tube (not shown) which encloses components 141a, 151a at least along the length of electrical transmission path 151a.

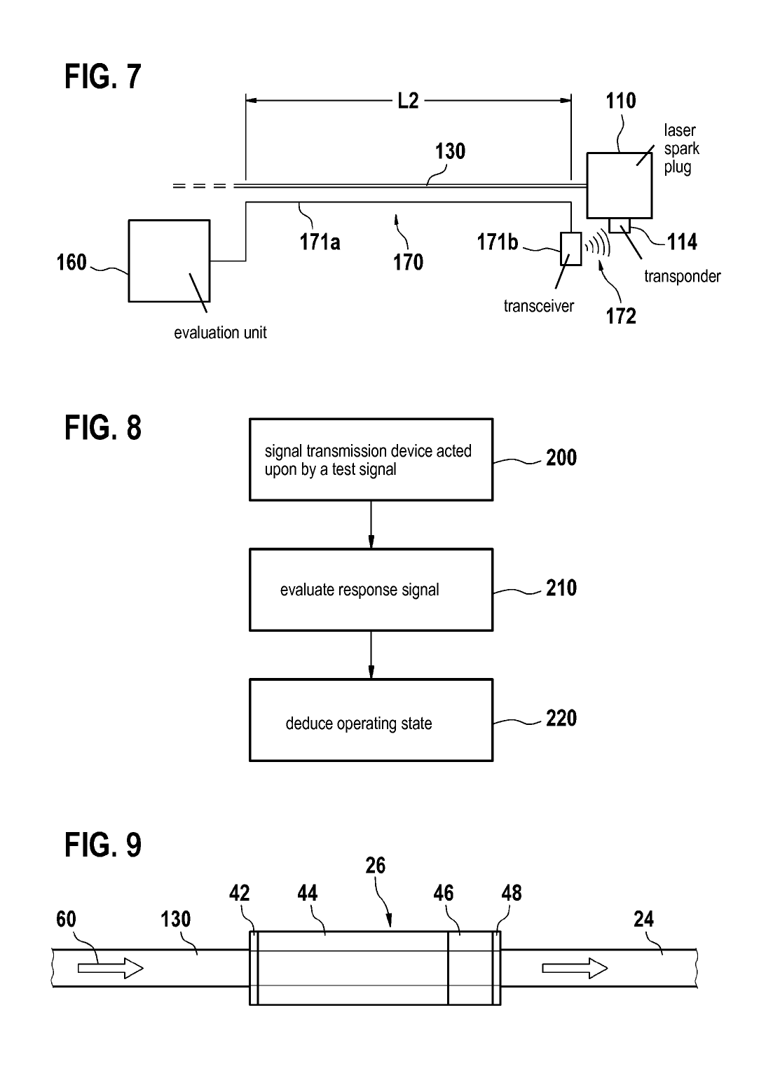

FIG. 7 shows another specific embodiment of the present invention in which an electrically operating signal transmission device 170 is provided which has an electrical transmission path 171a over a first length region L2. In this respect, the configuration from FIG. 7 corresponds to the system according to FIG. 2.

However, in the area of laser spark plug 110, electrical transmission path 171a becomes a wireless transmission path 172, which is made possible by connecting an appropriate transmitter or transceiver 171b to electrical connector 171a. Transceiver 171b allows a, preferably bidirectional, wireless connection to a corresponding transponder 114 situated in the area of laser spark plug 110, so that test pulses emitted by transceiver 171b reach transponder 114 as a wireless signal 172. Similarly, with proper functioning, transponder 114 may radiate received test signals back to transceiver 171b, which in turn are converted by transceiver 171b into wired electrical signals and transmitted back to evaluation unit 160 via transmission path 171a. In the configuration illustrated in FIG. 7, evaluation unit 160 may, for example, transmit test pulses via electrical connecting means 171a to transceiver 171b, and receive response signals in the form of signals reflected by transponder 114 and reverted to evaluation unit 160 by connector 171a, and evaluate same according to the present invention.

In accordance with the present invention, providing at least two signal transmission devices 140, 150, advantageously allows redundant monitoring of the mechanical or optical integrity of optical fiber device 130.

FIG. 9 shows a detailed view of laser device 26 as it is integrated into laser spark plug 110 according to FIG. 1b. As is apparent from FIG. 9, in addition to a laser-active solid 44, laser device 26 has a passive Q-switch 46, so that components 44, 46 together with an input mirror 42 and an output mirror 48 form a laser oscillator.

The basic mode of operation of laser device 26 is as follows: pumped light 60 which is supplied to laser device 26 via optical fiber device 130 enters through input mirror 42, which is transparent to a wavelength of pumped light 60, into laser-active solid 44. Pumped light 60 is absorbed there, resulting in a population inversion. The initially high transmission losses of passive Q-switch 46 prevent laser oscillation in laser device 26. However, with increasing pumping duration, the radiation density inside the resonator, formed by laser-active solid 44 and passive Q-switch 46 as well as mirrors 42, 48, also increases. Above a certain radiation density, passive Q-switch 46 or a saturatable absorber of passive Q-switch 46 fades, so that laser oscillation occurs in the resonator.

As a result of this mechanism, a laser beam 24 in the form of a so-called giant pulse is generated which passes through output mirror 48 and is used as a laser ignition pulse. Instead of passive Q-switch 46 described above, the use of an active Q-switch is also conceivable.

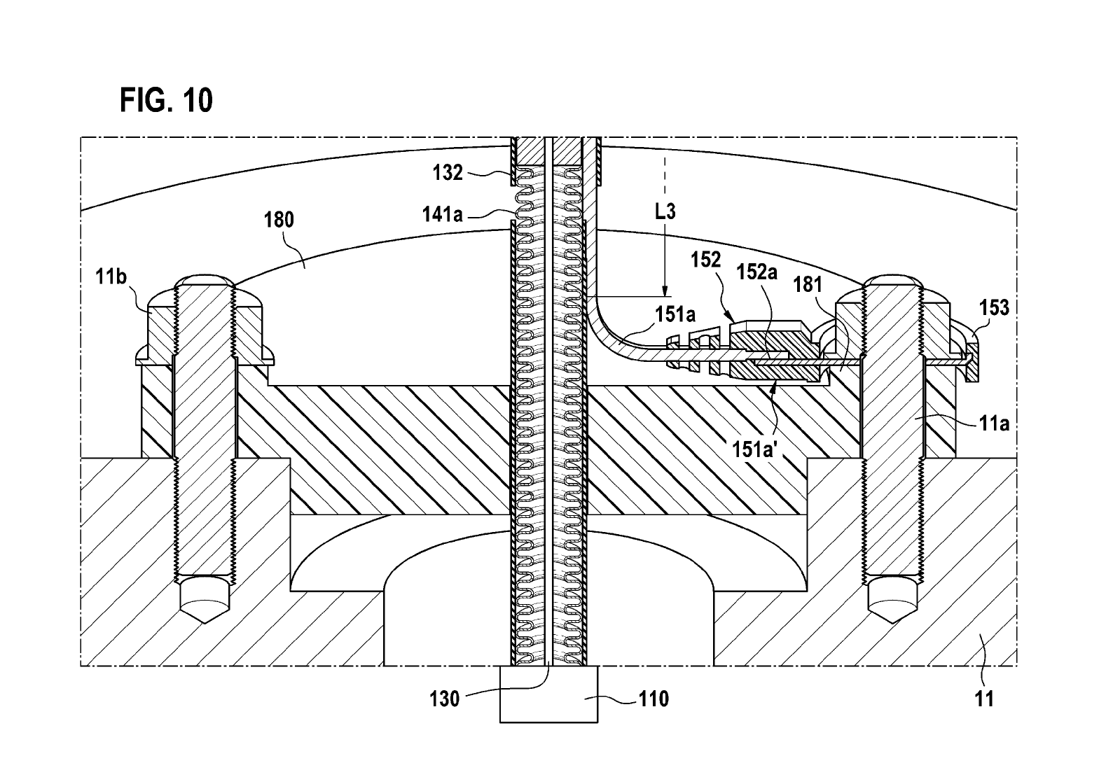

FIG. 10 shows a detailed view of another specific embodiment of the present invention, in which electrical transmission path 141 (FIG. 2) of first signal transmission device 140 is once again advantageously designed as an electrically conductive tube 141a. FIG. 10 shows a connecting area of tube 141a to laser spark plug 110.

In the specific embodiment illustrated in FIG. 10, the electrical transmission path of second signal transmission device 150 (FIG. 1a) is designed as an insulated signal conductor 151a. A tube 132 is situated around metal tube 141a and signal conductor 151a, and bundles these components 141a, 151a to simplify handling of system 110, 141a, 151a as a whole.

Insulated signal conductor 151a is guided parallel to protective tube 141a up to a defined length coordinate L3, measured along optical fiber device 130, and is held against the protective tube by tube 132.

A first end of signal conductor 151a, not illustrated in FIG. 10, and associated with evaluation unit 160, is electrically connected to evaluation unit 160 similarly as for the configuration shown in FIG. 5b. Signal conductor 151a thus implements a second channel for the monitoring principle according to the present invention, while metal tube 141a forms the first monitoring channel.

A second end 151a′ of signal conductor 151a situated in the area of laser spark plug 110 is connected to a ring cable lug 152 in an electrically conductive manner, for example with the aid of a clamping connection 152a. After laser spark plug 110 is installed, ring cable lug 152 is advantageously connected, in particular screwed, to a threaded piece 11a situated in the area of cylinder head 11 in such a way that an electrically conductive connection to vehicle ground GND is advantageously established (also see FIG. 5a), so that the signal transmission path between evaluation unit 160 and vehicle ground GND is completed.

In another advantageous specific embodiment, an ejection protection cover 180 is provided for laser spark plug 110, which, as is apparent from FIG. 10, is screwed to cylinder head 11 above laser spark plug 110 installed in the plug shaft (see threaded pieces 11a). Ejection protective cover 180 advantageously prevents a laser spark plug 110 which is possibly not properly connected to cylinder head 11 from being ejected.

Ejection protective cover 180 for laser spark plug 110 particularly advantageously has a mechanical coding which cooperates with a mechanical coding provided on ring cable lug 152 in such a way that an electrically conductive contact between ring cable lug 152, ejection protection cover 180, and threaded piece 11a to vehicle ground GND in the area of cylinder head 11 is established only when ring cable lug 152 is properly fastened to ejection protection cover 180.

This prevents, among other things, ground contact from inadvertently occurring between signal conductor 151a and a ring cable lug 152 which, for example, is situated loose on the engine and not screwed in, and, after an appropriate evaluation of signal transmission path 150 by evaluation unit 160, prevents pump module 120 from being accidentally enabled.

The mechanical coding particularly preferably provides that cable lug 152 is extrusion-coated with an electrically insulating plastic. The plastic forms a ring 153, so that cable lug 152 lying on a flat surface is not able to establish an electrical contact with the surface (cylinder head 11, for example) in any position. The electrical contact may result only via an elevated eye 181 in cover 180.

Cover 180 may also be made of plastic, in which case the ground contact is established via fastening elements 11a or a nut 11b which cooperates with same. Plastic cover 180 should preferably be mechanically stable enough that it may intercept plug 110 being ejected.

Particularly reliable monitoring of ignition system 100 is made possible as a result of the configuration shown in FIG. 10. In addition to checking for an interruption in optical fiber device 130 or transmission paths 141, 151 associated therewith, it is advantageously possible to check whether signal conductor 151a of the second monitoring channel is properly mounted on cylinder head 11. In addition, when an ejection protection cover 180 which has a mechanical coding is provided, the proper installation of signal conductor 151a on ejection protection cover 180 (and thus, the presence of ejection protection cover 180) may be checked by evaluation unit 160.

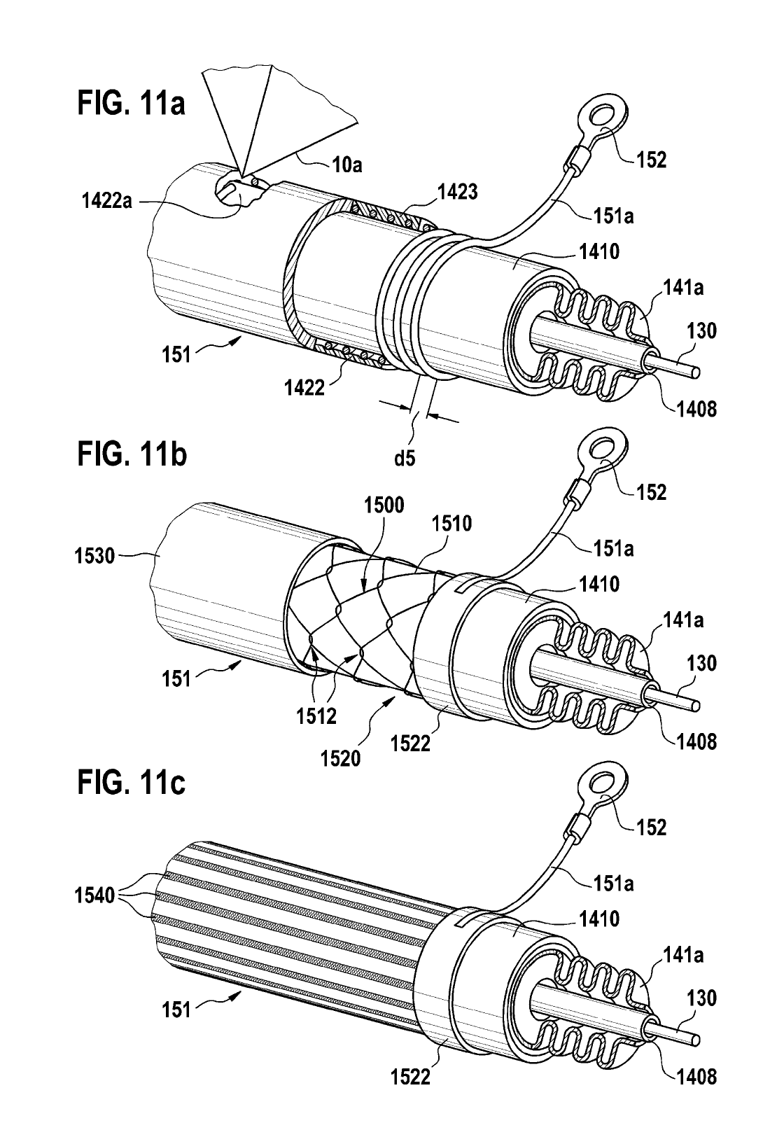

FIGS. 11a through 11c described below show further advantageous specific embodiments of a second electrical transmission path 151 for use with ignition system 100 according to the present invention. In these specific embodiments, a first electrical transmission path 141 is implemented in each case via a metal tube 141a which coaxially surrounds optical fiber device 130. The variants according to FIGS. 11a, 11b, 11c may in particular be advantageously combined with the configuration according to FIG. 10; i.e., conductor 151a from FIG. 10 may advantageously be designed according to FIGS. 11a, 11b, 11c.

FIG. 11a shows a cable device in which optical fiber device 130 is provided radially inwardly, and metal tube 141a, which implements first electrical transmission path 141, is provided radially surrounding the optical fiber device. An insulating tube 1410 which is electrically insulating is optionally situated around metal tube 141a. Alternatively or additionally, metal tube 141a itself may have electrical insulation of its radially outer surface, for example due to an appropriate insulating layer.

A metallic signal conductor 151a having a defined pitch, i.e., appropriate windings spaces d5, and in the present case not self-insulated, is wound onto insulating tube 1410 or the insulating surface of tube 141a.

The winding configuration of signal conductor 151a is fixed in position on protective tube 1410 by a sheath 1422 or an extrusion coating 1423. In order to avoid a shorted winding, the individual windings of signal conductor 151a should not touch one another.

In addition to the diagnostic principle according to the present invention previously described, the above-described configuration of signal conductor 151a may advantageously be used to recognize wearing through of optical fiber sheath 1422 or 1423.

Namely, when a portion of protective tube 1422 contacts, for example, a part 10a of engine 10 during operation, material may be abraded from protective tube 1422 over time. This material removal 1422a initially interrupts signal conductor 151a, and, due to the monitoring by evaluation unit 160 with the aid of test signals, triggers a safety cutoff of pump module 120 before a hole results in sheath 141a around optical fiber 130 itself, and a hazard develops from laser light 60 escaping into the surroundings.

Signal conductor 151a may also advantageously be designed as enameled copper wire, for example, so that a separate insulating tube 1410 or an electrically insulating design of the radially outer surface of metal tube 141a may be dispensed with.

Optionally, an additional inner protective tube 1408 may also be provided around optical fiber 130 which protects same from wear due to internal friction at metallic outer tube 141a, for example. If inner protective tube 1408 is designed to be light-proof against laser radiation 60, the inner protective tube advantageously forms an additional barrier against unwanted escape of pump radiation 60.

For the evaluation of a test signal which, for example, is coupled into signal conductor 151a by evaluation unit 160, it should be ensured that the components which implement transmission path 151 are able to contact a metallic engine part 10a which is at ground potential GND of engine 10. A contact in the area of interruption 1422a of conductor 151a would thus not be distinguishable from a proper electrical contact via cable lug 152 (FIG. 10). However, due to vibrations of engine 10 it is extremely unlikely that this contact is continuously present. Therefore, the error may be detected with a very high degree of probability by evaluation unit 160 triggering at the first interruption of measuring loop or transmission path 151 (for example, by deactivating pump module 120), and the pump module may also be deactivated when the connection to ground potential GND is subsequently restored. An additional increase in the precision of the evaluation results when the electrical connection between evaluation unit 160 and ground potential GND in the area of laser spark plug 110 is continuously monitored at a sampling frequency that is greater than the expected vibration frequency of system 10, 11, and which in particular is more than twice the vibration frequencies.

In another specific embodiment, the spiral of signal conductor 151a according to FIG. 11a is imprinted on tube 1410 in the form of a conductive lacquer, for example, or as a dual-component part as conductive plastic which is embedded in the insulating plastic.

In another possible specific embodiment (see FIG. 11b), signal conductor 151a is not spirally wound onto insulating tube 1410, at least in sections, but instead is knitted to form a conductive tube 1500 in the manner of a net. This has the advantage that this netting tube 1500 is produced separately from protective tube 1410 or 141a, and only in a subsequent production step is it possible to slide it over the protective tube.

The netting of tube 1500 should preferably be knitted from a single, preferably electrically insulated, wire 1510 in a sufficient density that the distances between net nodes 1512 are smaller than the distances between possible wear points 1422a (FIG. 11a). End 1520 of netting tube 1500 facing laser spark plug 110 may be secured (i.e., fixed) in position on protective tube 1410 by a metal ring 1522 and connected to ring cable lug 152. A further sheath 1530 for fixing and insulating ring 1522, among other things, may completely or partially surround the system.

Another advantageous specific embodiment of the present invention operates with resistance tracks 1540 which are situated, in particular imprinted, on insulating tube 1410, and which preferably extend essentially in the longitudinal direction, i.e., along optical fiber 130. According to one preferred specific embodiment, multiple or all resistance tracks 1540 are electrically connected in parallel, which is achievable, for example, by metal rings 1522 on the pump module side (not shown) and on the laser spark plug side (FIG. 11c).

It is apparent from FIG. 11c that a metal ring 1522 which contacts resistance tracks 1540 is connected via line 151a to ring cable lug 152 having ground potential GND (see FIG. 10). In this variant of the present invention, the evaluation by evaluation unit 160 provides that the resistance of resistance tracks 1540 is measured. As soon as one of resistance tracks 1540 is worn through or damaged or altered in some other way, the resistance of transmission path 151 changes, and pump module 120 is switched off.

In one particularly preferred specific embodiment, the number of resistance tracks 1540 and their mutual spacing along a peripheral direction on tube 1410 is selected in such a way that on the one hand, a wear point 1422a (FIG. 11a) is reliably detected by the evaluation according to the present invention. For example, for a diameter of tube 1410 of approximately 10 mm, a number of resistance tracks 1540 from approximately 20 to approximately 100 may be provided.

On the other hand, the interruption of an individual resistance track 1540 in the course of the evaluation of the resistance of transmission path 151 should still be reliably recognizable; i.e., for 100 resistance tracks 1540, for example, evaluation unit 160 must be able to reliably detect a change of 1% of the resistance value. In addition, this 1% change must be much greater than possible changes in the resistance of remaining transmission path 151 from evaluation unit 160 to cable lug 152, from there over screwed connection 11a and the other ground cabling of engine 10, back to evaluation unit 160. This is advantageously the case, for example, when the resistance of individual resistance tracks 1540 is in the kiloohm range.

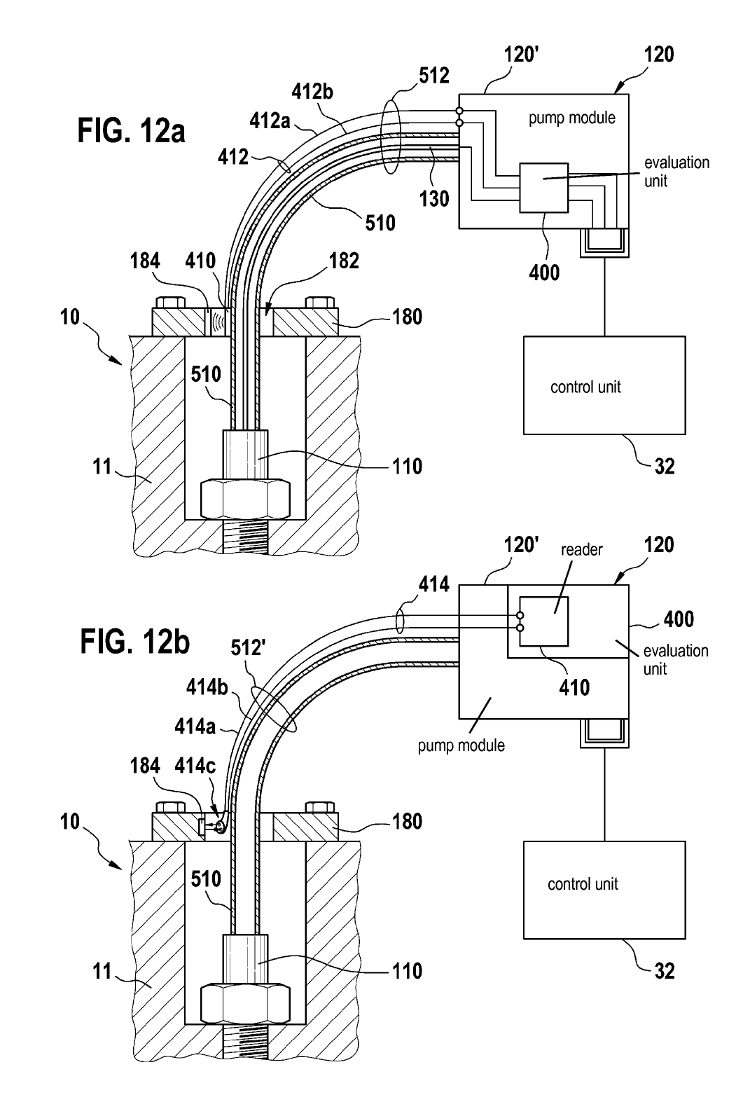

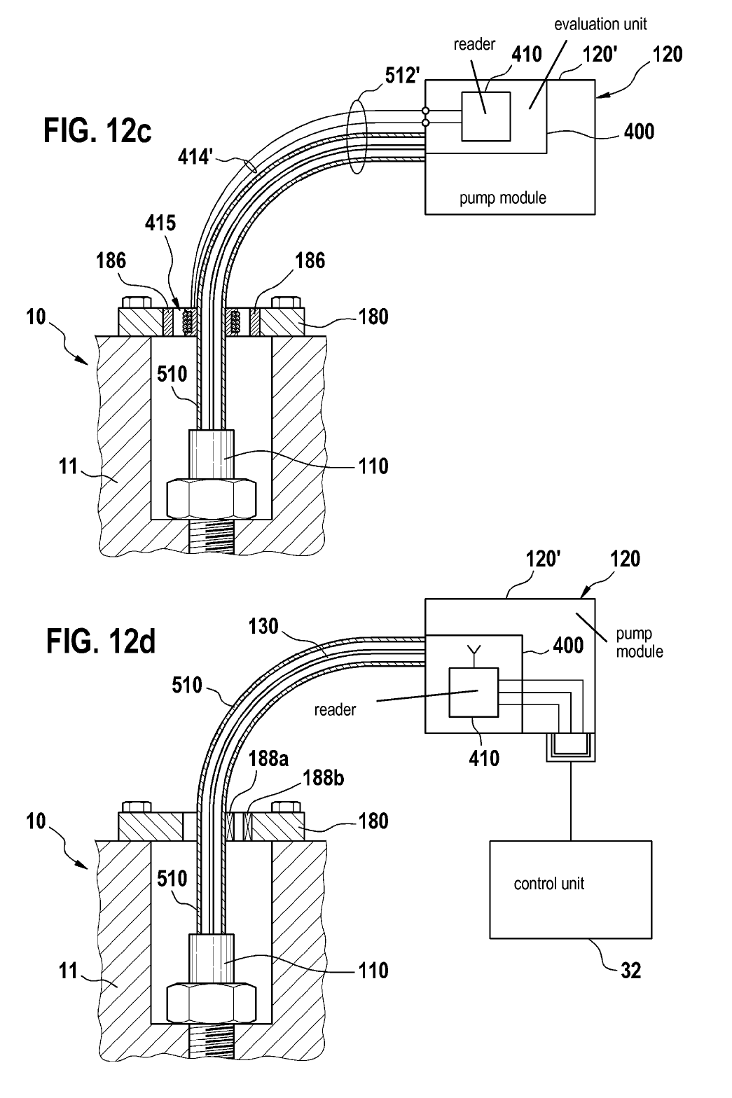

FIG. 12a shows another specific embodiment of the present invention in which laser spark plug 110 in its installed position is situated in cylinder head 11 of internal combustion engine 10. Similarly to the specific embodiment according to FIG. 10, in the variant according to FIG. 12a an ejection protection cover 180 is also provided above the plug shaft containing laser spark plug 110.

Cover 180 has an opening 182 for leading cable 510 through. Cable 510 may preferably have optical fiber device 130 as well as signal transmission devices 140, 150, and in particular also a metal tube 141a (FIG. 3), which are not illustrated in FIG. 12a for the sake of clarity.

In the present specific embodiment, cover 180 also has at least one identification sensor 184 which is designed to wirelessly transmit an identification signal to an evaluation unit 400, which acts on identification sensor 184 with a query signal. For this purpose, evaluation unit 400 may have a suitably designed reader 410.

In one preferred specific embodiment, identification sensor 184 is designed as a radio frequency identification (RFID) transponder, and is situated on cover 180 in the area of opening 182.

Evaluation unit 400 may, for example, be integrated into a control device 32 which controls laser spark plug 110, or in the present case as shown in FIG. 12a, may be integrated into pump module 120, and RFID reader 410 may be situated in the area of cable 510 and/or spark plug 110, and connected to same to be able to establish a wireless connection with identification sensor 184.

Alternatively or in addition to the design of identification sensor 184 as an RFID transponder, the identification sensor may also have a magnetically conductive material, in particular a ferrite material, thus allowing recognition of the identification sensor by use of the induction principle.

A further increase in the operating reliability of ignition device 100 according to the present invention is provided by designing cover 180 to be impermeable to laser radiation, in particular pump radiation 60. In particular also when there is a break in cable 510 or optical fiber 130 guided therein within the spark plug shaft, laser radiation 60 is thus prevented from escaping from the spark plug shaft into the surroundings.

Cover 180 may advantageously be made at least of plastic and/or metal and/or a magnetically conductive material, in particular a ferrite material. Cover 180, regardless of the material used for this purpose, is particularly preferably designed to be mechanically stable enough that it is able to intercept a spark plug 110 being ejected.

Evaluation unit 400, which is designed to carry out wireless communication with RFID identification sensor 184 integrated into cover 180, is provided in housing 120′ of pump module 120, which according to FIG. 12a is situated remotely from spark plug 110.

For this purpose, evaluation unit 400 is connected via a cable connection 412 to RFID reader 410, which in the present case is situated on cable 510, and in particular in such a way that it comes to rest in the area of identification sensor 184 of cover 180 when spark plug 110 is in the correctly installed position in cylinder head 11.

Cable connection 412 to RFID reader 410 may have, for example, two individual cables 412a, 412b, which particularly preferably may also be combined with cable 510 of laser spark plug 110 to form an overall cable assembly 512.

To check whether laser spark plug 110 or cover device 180 is properly situated on cylinder head 11, evaluation unit 400 acts on RFID reader 410 with a control instruction, and the RFID reader then transmits a query signal to identification sensor 184 of cover device 180. Identification sensor 184 designed as an RFID transponder responds to the query signal in a conventional manner with an identification signal which it sends back to RFID reader 410.

After receipt of the identification signal, RFID reader 410 relays pieces of information as a function thereof to evaluation unit 400.

Evaluation unit 400 compares the information obtained from identification sensor 184 to pieces of information which preferably are not stored in the volatile memory of evaluation unit 400, and only when a match or a positive association of pieces of information with one another has been determined does evaluation unit 400 enable control of laser spark plug 110 by pump module 120.

As a result of the above evaluation of the data obtained from identification sensor 184, it may advantageously be determined, on the one hand, whether spark plug 110 or cable 510 having RFID reader 410 is in the proper installed position with respect to cover 180 or identification sensor 184 situated therein. On the other hand, by evaluating the identification signal emitted by identification sensor 184, it may also be checked whether spark plug 110 is assigned to a compatible target system 11 which is associated with cover device 180 or its identification sensor 184.

The checking, made possible according to the present invention, of a proper installation thus advantageously also includes the option, for example, of assigning a particular code on the identification sensor to a certain variant of the spark plug having certain properties. Thus, for example, it may be checked whether the correct engine-specific variant of the spark plug is installed in the correct engine. This sort of type coding is also possible to a limited extent using the inductive method (the number of geometric variants is small compared to the possibilities of numerical coding with the aid of an RFID transponder).

The variant of the present invention described above with reference to FIG. 12a may also advantageously be combined with the variants described above with reference to FIGS. 1a through 11c. In particular, the RFID communication according to FIG. 12a may also be regarded as a further transmission path 140, 150 within the meaning of the present invention. Accordingly, the functionality of evaluation unit 400 may also be integrated into evaluation unit 160 (FIG. 1a).

Furthermore, for example a metal tube 141a (FIG. 3) associated with cable 512 may at the same time also advantageously replace one of cable connections 412a, 412b required for the RFID communication. Thus, in this case metal tube 141a, which itself is a component of a transmission path 140, forms a signal connection between an evaluation unit 160, 400 and RFID reader 410 for implementing the RFID communication.

FIG. 12b shows another specific embodiment of an ignition device according to the present invention for an internal combustion engine.

In contrast to the configuration according to FIG. 12a, RFID reader 410 is now situated in evaluation unit 400, which is integrated into housing 120′ of pump module 120.

Via cable connection 414 having the two individual conductors 414a, 414b, an RFID read signal or the query signal according to the present invention is transmitted to an antenna device 414c situated in the area of cover device 180. This means that between reader 410 and antenna device 414c, the query signal according to the present invention is transmitted in a wired manner, namely, via cable connection 414. Cable connection 414 is accordingly designed, for example, as a transmission cable suitable for high frequency, in particular as a coaxial cable. Only in antenna device 414c is the query signal transformed into a wireless signal and sent to identification sensor 184.

Antenna device 414c is also designed to receive an identification signal sent by identification sensor 184, for example in response to a query signal, to transform the identification signal into a wired information signal, and to transmit same to the evaluation unit or reader 410 situated therein.

The evaluation process is comparable to the method steps explained above with reference to FIG. 12a.

In the present case, cable connection 414 may also be advantageously combined with cable 510 of spark plug 110 to form a cable assembly 512′.

FIG. 12c shows another specific embodiment of the ignition device according to the present invention, in which a solenoid 415 is provided in the area of cover device 180 and cooperates with a ferrite material 186 associated with cover device 180. Solenoid 415 is preferably situated on cable 510, and in particular is fixed at a particular length coordinate which corresponds to the installed distance between cover 180 and laser spark plug 110.

Evaluation unit 400 or reader 410 situated therein acts on solenoid 415 with an operating voltage, thus forming a magnetic field in the area of solenoid 415 which interacts with the ferrite material of identification sensor 186.

In the absence of ferrite identification sensor 186, a different magnetic field configuration results in the area of solenoid 415 which is detectable by evaluating in a conventional manner the currents or voltages transmitted by cable connection 414′.

The above-described configurations 184, 186 of the identification sensor are also combinable with one another. In particular, cover device 180 may have at least one first identification sensor 184 designed as an RFID transponder and at least one second identification sensor 186 having a ferrite material; evaluation unit 400 is to be appropriately set up for querying both identification sensors 184, 186.

In addition, cable connections 414′ provided for controlling solenoid 415 may advantageously be combined with cable 510 of laser spark plug 110 to form a cable assembly 512′.

FIG. 12d shows another specific embodiment of the ignition device according to the present invention in which an RFID reader 410 is situated in housing 120′ of pump module 120. A first RFID transponder 188a is situated around cable 510 of laser spark plug 110 at a position defined with respect to cover device 180. A second RFID transponder 188b is situated opposite from first RFID transponder 188a, but in contrast to first transponder 188a is fastened to cover device 180, not to cable 510.

The two transponders 188a, 188b are coordinated with one another in such a way that only when both transponders are close to one another do they form a resonant circuit which is configured to suitably respond to the query signal of RFID reader 410 with an identification signal. Thus, provided that transponders 188a, 188b are in the proper position relative to one another, evaluation unit 400 may in turn deduce that laser spark plug 110 is properly installed and situated with respect to cover device 180. In this case, evaluation unit 400 may enable the control of laser spark plug 110 by pump module 120.

However, if the two transponders 188a, 188b are not sufficiently close to one another in the area of cylinder head 11 due to improper mounting of laser spark plug 110, in order to respond to a query signal of RFID reader 410 as specified, evaluation unit 400 deduces that laser spark plug 110 is not in a properly installed position, and does not enable the control of laser spark plug 110.

The above-described specific embodiments of the present invention may also advantageously be combined with one another. In particular, the functionality of evaluation units 160, 400 may be implemented in a single evaluation unit which is integratable into pump module 120 or also control unit 32, for example.

The cable connections used for implementing an RFID communication (specific embodiments of FIGS. 12a through 12d) may advantageously be used at the same time for implementing signal transmission devices 140, 150 or corresponding transmission paths. For example, cables 412a, 412b according to FIG. 12a which supply RFID reader 410 may be connected to one another in the area of RFID reader 410 via a testing resistor of several kohm. The exact resistance value of the testing resistor is selected in such a way that communication between units 400, 410 is not impaired. In addition to regular communication between units 400, 410, evaluation unit 160 or 400 may also advantageously transmit a test signal (voltage pulse) via lines 412a, 412b which causes a corresponding current flow over the testing resistor. If an appropriate current flow is not detected by evaluation unit 160 or 400, an interruption of transmission path 140 implemented by lines 412a, 412b may be deduced, and the activation of pump module 120 may be prevented, for example.

Further advantageous combinations of the above-described variants of the present invention, in particular making multiple use of existing lines 412a, 412b, etc., are likewise possible.

It is also advantageously possible to provide the outside of cable 512 according to the specific embodiments according to FIGS. 12a through 12d with a signal conductor 151a or a transmission path 151 according to FIGS. 11a through 11c.

1-15. (canceled)

16. An ignition system for an internal combustion engine of a motor vehicle, comprising:
a laser spark plug;
a pump module to supply the laser spark plug with pump radiation;
an optical fiber device to transmit the pump radiation from the pump module to the laser spark plug;
at least two separate signal transmission devices which each extend at least partially along the optical fiber device; and
an evaluation unit to act on each of the signal transmission devices with a test signal, evaluate a response signal of the signal transmission devices which results from the particular test signal, and deduce from the response signal an operating state of the corresponding signal transmission device.

17. The ignition system as recited in claim 16, wherein a first one of the signal transmission devices has at least one first electrical transmission path between the evaluation unit and an area of a housing of the laser spark plug which is connected to an electrical reference potential of a target system when the laser spark plug is installed in the target system.

18. The ignition system as recited in claim 17, wherein the target system is a cylinder head of an internal combustion engine.

19. The ignition system as recited in claim 17, wherein the first electrical transmission path has an electrically conductive tube which surrounds the optical fiber device.

20. The ignition system as recited in claim 16, wherein a second one of the signal transmission devices has at least one second electrical transmission path between the evaluation unit and a connecting area of the optical fiber device to the laser spark plug, and the second electrical transmission path has an insulated electrical conductor which is situated at least one of along the optical fiber device, and an electrically conductive tube surrounding the optical fiber device.

21. The ignition system as recited in claim 16, wherein the evaluation unit is configured to apply a voltage between a reference potential of the evaluation unit and the electrical transmission path as a test signal, and the evaluation unit is designed to evaluate a current, which, due to an applied voltage, flows through the electrical transmission path of the signal transmission devices as a response signal of the signal transmission devices.

22. The ignition system as recited in claim 16, wherein at least one of the signal transmission devices is situated along the optical fiber device and extends over at least 80 percent of a total length of the optical fiber device.

23. The ignition system as recited in claim 16, wherein at least one of the signal transmission devices has at least one optical transmission path.

24. The ignition system as recited in claim 16, wherein at least one of the signal transmission devices has a wireless transmission path, at least in parts.

25. The ignition system as recited in claim 16, wherein the signal transmission devices include multiple homogeneous signal transmission devices.

26. The ignition system as recited in claim 16, wherein the evaluation unit is designed to simultaneously or consecutively act on multiple signal transmission devices with test signals to deduce an optical integrity of the optical fiber device from response signals thus obtained.

27. The ignition system as recited in claim 16, wherein the pump module is deactivatable when an error has been ascertained in an area of at least one of the signal transmission devices.

28. A method for operating an ignition system for an internal combustion engine of a motor vehicle, the ignition system having a laser spark plug, a pump module to supply the laser spark plug with pump radiation, and an optical fiber device for transmitting the pump radiation from the pump module to the laser spark plug, wherein at least two separate signal transmission devices which each extend at least partially along the optical fiber device are provided, and an evaluation unit, the method comprising:
acting on each of the signal transmission devices, by the evaluation unit, with a test signal;
evaluating, by the evaluation unit, a response signal of the signal transmission device which results from the particular test signal; and
deducing from the response signal an operating state of a corresponding signal transmission device, by the evaluation unit.

29. The method as recited in claim 28, wherein a first one of the signal transmission devices has at least one first electrical transmission path between the evaluation unit and an area of a housing of the laser spark plug which is connected to an electrical reference potential of a target system when the laser spark plug is properly installed in the target system, a second one of the signal transmission devices has at least one second electrical transmission path between the evaluation unit and a connecting area of the optical fiber device to the laser spark plug, the second electrical transmission path has an insulated electrical conductor which is situated along the optical fiber device, the method further comprising:
applying, by the evaluation unit, voltage between a reference potential of the evaluation unit and the electrical transmission path as a test signal; and
evaluating, by the evaluation unit, a current, which, due to the applied voltage, flows through the electrical transmission path of the signal transmission device as a response signal of the signal transmission device.

30. The method as recited in claim 28, further comprising:
simultaneously or consecutively acting on multiple signal transmission devices with test signals, by the evaluation unit, to deduce an optical integrity of the optical fiber device from response signals thus obtained.

31. The method as recited in claim 29, further comprising:
deactivating the pump module when an error has been ascertained in an area of at least one signal transmission device.
